(19) United States
(12) Patent Application Publication
(10) Pub. No.: US 2020/0111170 A1
(43) Pub. Date: Apr. 9, 2020

(54) SYSTEM AND METHOD FOR VEHICLE CRASH EVENT DATA ANALYSIS AND COST/LOSS ESTIMATION

(71) Applicant: RUSS OLDHAM, SCOTTSDALE, AZ (US)

(72) Inventor: RUSS OLDHAM, SCOTTSDALE, AZ (US)

(21) Appl. No.: 16/701,421

(22) Filed: Dec. 3, 2019

Related U.S. Application Data
(60) Provisional application No. 62/740,807, filed on Oct. 3, 2018.

(51) Int. Cl. G06Q 40/08; G07C 5/00; G06Q 30/02; G06Q 50/26

(52) U.S. Cl. CPC G06Q 40/08; G07C 5/008; G06Q 50/265; G06Q 30/0283; G06Q 30/0278

(57) ABSTRACT

A computing device has a processor. A display is coupled the processor. A user interface is coupled to the processor for entering data into the computing device. A memory is coupled to the processor, the memory storing program instructions that when executed by the processor, causes the processor to: receive telemetry data from a vehicle involved in an accident; map the incoming data to a standard data model to transform the telemetry data to a common standard data; analyze the common standard data; determine estimated repair cost of the vehicle based on the analysis of the common standard data; determine if the repair cost exceeds a predetermined threshold percentage of an actual cash value of the vehicle; and request a salvage service if the repair cost exceeds the predetermined threshold percentage of the actual cash value of the vehicle.

### RELATED APPLICATIONS

This patent application is related to U.S. Provisional Application No. 62/740,807 filed Oct. 3, 2018, entitled “VEHICLE CRASH EVENT DATA AUTOMATED ANALYSIS AND RESPONSE SYSTEM” in the name of Russ Oldham, and which is incorporated herein by reference in its entirety. The present patent application claims the benefit under 35 § 119(e).

### FIELD

The present application generally relates to vehicles, and, more particularly, to a vehicular application that retrieves event data and provides damage assessment as well as digital damage appraisal, vehicle total loss identification, vehicle recovery notification, vehicle salvage notification, Public Safety Answering Points (PSAP) notification, and event reconstruction.

### BACKGROUND

Everyday automobiles are involved in collisions. Following these collisions, a series of responsive actions should be taken by different individuals and/or institutions. These actions may include, but are not limited to: contacting local emergency services, the vehicle operator, salvage companies, and more. Insurance carriers and risk management entities are unable to afford an immediate, consolidated crash event and claim management system and must rely on internal workflow processes for response, direction, deployment and recovery activities. Included in these are the following evaluations: driver safety responses, including local emergency service notification, vehicle recovery or salvage, damage assessment and repair estimate, total loss, of vehicle value identification, mapping of vehicle movement both pre and post-collision, collection of critical decision-making information into a single, consolidate system of record.

Much of the above procedure may be done by a claims adjuster of the insurance company. The claims adjuster may inspect the vehicle in the field. However, the inspection may not occur for several days after the accident has been reported to the insurance company. Further, due to limitations in information gathering and evaluation that follow a crash event, individual steps are often resolved inefficiently or inaccurately. These decisions involve several personnel-initiated actions and in most cases are very time consuming. During that period, storage and transportation fees accrue associated with the vehicle, supplementary vehicle rental fees, and other related costs continue to compound. By determining the extent of damage seconds after the collision occurs, one could substantially accelerate that linear and costly process into an immediate and automated response requiring minimal to no personnel-initiated actions; optimizations that offer significant savings in time and money.

Therefore, it would be desirable to provide a system and method that overcome the above identified concerns, as well as additional challenges which will become apparent from the disclosure set forth below.

### SUMMARY

This summary is provided to introduce a selection of concepts in a simplified form that are further described below in the DESCRIPTION OF THE APPLICATION. This summary is not intended to identify key features of the claimed subject matter, nor is it intended to be used as an aid in determining the scope of the claimed subject matter.

In accordance with one aspect of the present application, a computing device is disclosed. The computing device has a processor. A display is coupled to the processor. A user interface is coupled to the processor for entering data into the computing device. A memory coupled to the processor, the memory storing program instructions that when executed by the processor, causes the processor to: receive telemetry data from a vehicle involved in an accident; map the incoming data to a standard data model to transform the telemetry data to a common standard data; analyze the common standard data; determine estimated repair cost of the vehicle based on the analysis of the common standard data; determine if the repair cost exceeds a predetermined threshold percentage of an actual cash value of the vehicle; and request a salvage service if the repair cost exceeds the predetermined threshold percentage of the actual cash value of the vehicle.

In accordance with one aspect of the present application, a method of determining when a vehicle is repaired or salvaged after an accident is disclosed. The method comprises: receiving telemetry data from a vehicle involved in an accident; mapping the incoming data, to a standard data model to transform the telemetry data to a common standard data; analyzing the common standard data; determining estimated repair cost of the vehicle based on the analysis of the common standard data; determining if the repair cost exceeds a predetermined threshold percentage of an actual cash value of the vehicle; requesting a salvage service if the repair cost exceeds the predetermined threshold percentage of the actual cash value of the vehicle; selecting an appraiser for repairing the vehicle if the repair cost is below the predetermined threshold percentage of the actual cash value of the vehicle; and establishing a unique link for the selected appraiser, the link allowing the appraiser to upload photos and a quote for repair.

### BRIEF DESCRIPTION OF THE DRAWINGS

Embodiments of the disclosure will become more fully understood from the detailed description and the accompanying drawings, wherein:

FIG. 1 is a block diagram of an exemplary cost estimation system in accordance with one embodiment of the present invention;

FIG. 2 is a block diagram of an exemplary computing device used in the cost estimation system of FIG. 1 in accordance with one embodiment of the present invention;

FIG. 3 is an exemplary vehicle having sensors used in the cost estimation system of FIG. 1 in accordance with one embodiment of the present invention;

FIG. 4 is an exemplary block diagram showing collection of data by the system of FIG. 1 in accordance with one embodiment of the present invention;

FIG. 5 is an exemplary block diagram showing different actual cash value determinations used in the system of FIG. 1 in accordance with one embodiment of the present invention;

FIG. 6 is an exemplary chart showing cost of repair versus a percentage of actual cash value to determine repairability of the vehicle used in the system of FIG. 1 in accordance with one embodiment of the present invention;

FIG. 7 is an exemplary chart showing impact zone threshold levels used in the system of FIG. 1 in accordance with one embodiment of the present invention;

FIG. 8 is a chart showing automated and user-initiated functions for the system of FIG. 1 in accordance with one embodiment of the present invention;

FIG. 9, is an exemplary flowchart showing operation of the system of FIG. 1 in accordance with one embodiment of the present invention; and

FIG. 10 is an exemplary flowchart showing operation of the system of FIG. 1 in accordance with one embodiment of the present invention.

### DESCRIPTION OF THE INVENTION

The description set forth below in connection with the appended drawings is intended as a description of presently preferred embodiments of the disclosure and is not intended to represent the only forms in which the present disclosure can be constructed and/or utilized. The description sets forth the functions and the sequence of steps for constructing and operating the disclosure in connection with the illustrated embodiments. It is to be understood, however, that the same or equivalent functions and sequences can be accomplished by different embodiments that are also intended to be encompassed within the spirit and scope of this disclosure.

The present disclosure relates to a vehicle crash event data analysis and cost/loss estimation system/application. The system/application is configured to transform the process following the collision of an automobile into an immediate and automated series of evaluations and actions from the analysis of the event data. The system/application is designed to receive event data from a variety of sources and data collection speeds with varying data precision quality while still confidently executing workflows. These automated actions and evaluations include but arc not limited to: vehicle total loss identification, vehicle recovery notification, vehicle salvage notification, Public Safety Answering Points (PSAP) notification, event reconstruction, third party crowdsourcing communication relaying digital damage assessments as well as digital damage appraisal, event reconstruction, with analysis model enhancements being continually refined using machine learning practices.

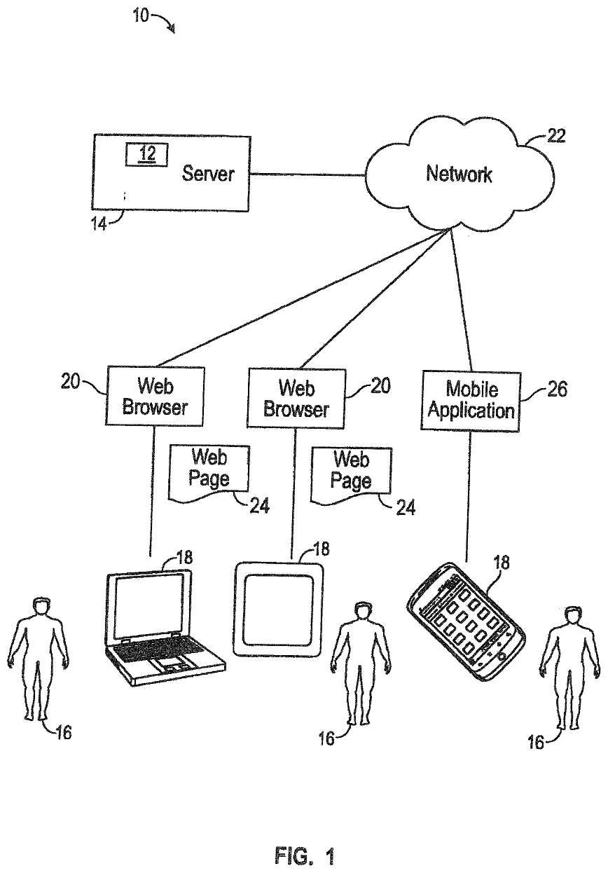

Referring now to FIG. 1, a system 10 may be shown. The system 10 may be a cloud-based system that may provide a platform 12 that may allow for vehicle crash event data analysis/ cost/loss estimation, as well as other features that may be described below. The system 10 may have a server 14. The server 14 may be used to host the platform 12 of the present invention. Individuals 16 may use one or more computing devices 18 to access the platform 12 that may be hosted on the server 14. The computing devices 18 may be a personal computer system, tablet device, handheld or laptop device, mobile phone device, server computer system, multiprocessor system, microprocessor-based system, set top boxes, programmable consumer electronics, network PCs, and distributed cloud computing environments that include any of the above systems or devices, and the like. The computing device 18 may be described in the general context of computer system executable instructions, such as program modules, being executed by a computer system as may be described below.

The computing device 18 may be loaded with an operating system. The operating system of the computing device 18 may manage hardware and software resources of the computing device 18 and provide common services for computer programs running on the computing device 18. The computing device 18 may be loaded with a web browser 20. The web browser 20 may allow the computing device>18 to gain online access to a network 22 such as the World Wide Web. The web browser 20 may be Microsoft® Internet Explorer, Google® Chrome, Mozilla® Firefox, Apple® Safari or similar browsing applications. By connecting to the network 22, the computing device 18 may access a website 24 associated with the platform hosted on the server 14.

Alternatively, or in addition to, the computing device 18 may download a mobile application 26. The mobile application 26 may access and communicate with the platform 12 hosted on the server 14. By connecting to the network 22, the computing device 18 may access and communicate with the platform 12 hosted on the server 14 via the mobile application 26.

In accordance with one embodiment, the application 12 may be accessed and initiated by a signal received by a computing device 18 located within a vehicle 60 (F1G. 3). The vehicle 60 may send data signals to the application 12 upon initiation of an event as may be shown below.

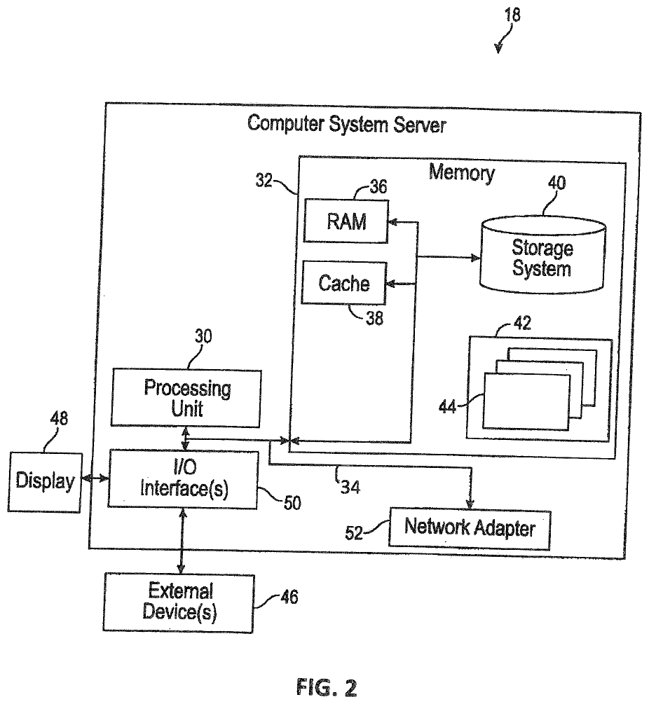

Referring now to FIG. 2, the computing devices 18 may be described in more detail in terms of the machine elements that provide functionality to the systems and methods disclosed herein. The components of the computing devices 18 may include, but are not limited to, one or more processors or processing units 30, a system memory 32, and a system bus 34 that couples various system components including the system memory 32 to the processor 30. The computing devices 18 may typically include a variety of computer system readable media. Such media could be chosen from any available media that is accessible by the computing devices 18, including non-transitory, volatile and non-volatile media, removable and non-removable media. The system memory 32 could include one or more computer system readable media in the form of volatile memory, such as a random-access memory (RAM) 36 and/or a cache memory 38. By way of example only, a storage system 40 may be provided for reading from and writing to a non-removable, non-volatile magnetic media device typically called a “hard drive”.

The system memory 32 may include at least one program product/utility 42 having a set (e.g., at least one) of program modules 44 that may be configured to carry out the functions of embodiments of the invention. The program, modules 44 may include, but is not limited to, an operating system, one or more application programs, other program modules, and program data. Each of the operating systems, one or more application programs, other program modules, and program data or some combination thereof, may include an implementation of a networking environment. The program modules 44 generally carry out the functions and/or methodologies of embodiments of the invention as described herein. For example the program modules 44 may carry out the steps for initiating an event creation, private and group communication between invitees to the event created, visual and/or textual summaries of past events of individuals and other functionality as will be described below.

The computing device 18 may communicate with one or more external devices 46 such as a keyboard, a pointing device, a display 48, and/or any similar devices (e.g., network card, modern, etc.) that enable the computing device 18 to communicate with the server 14 (FIG. 1). Such communication may occur via Input/Output (I/O) interfaces 50. Alternatively, the computing devices 18 may communicate with one or more networks such as a local area network (LAN), a general, wide area;network (WAN), and/or a public network (e.g., the network 24 shown in FIG. 1) via a network adapter 52. As depicted, the network adapter 52 may communicate with the other components of the computing device 18 via the bus 36.

As will be appreciated, by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, microcode, etc.) or an embodiment combining software and hardware aspects that may all generally be referred to herein as a “circuit,” “module,” or “system.” Furthermore, aspects of the disclosed invention may take the form of a computer program product embodied in one or more computer readable media having computer readable program code embodied thereon.

Any combination of one or more computer readable media (for example, storage system 40) may be utilized. In the context of this disclosure, a computer readable storage medium may be any tangible or non transitory medium that can contain, or store a program (for example, the program product 42) for use by or in connection with an instruction execution system, apparatus, or device. A computer readable storage medium may be, for example, but not limited to, an electronic, magnetic, optical, electromagnetic, infrared, or semiconductor system, apparatus, or device, or any suitable combination of the foregoing.

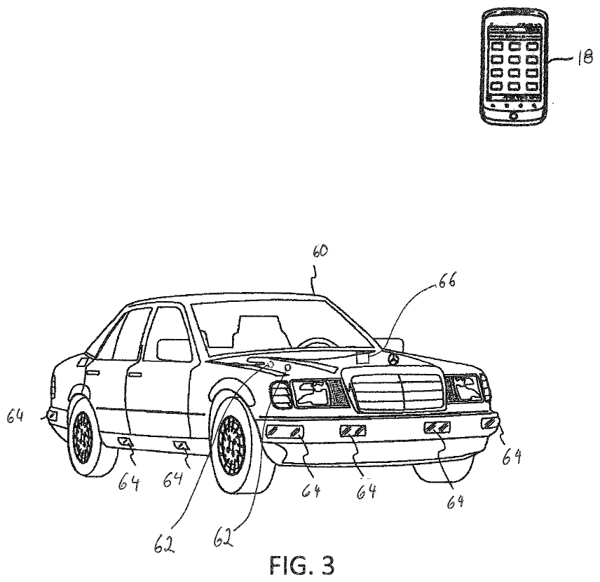

Referring to FIG. 3, a vehicle 60 may be shown which may use the system 10 of FIG. 1. The vehicle 60 may have a first plurality of sensors 62 installed thereon. The sensors 62 may monitor different operating conditions of the vehicle 60. The sensors 62 may monitor speed, location, fluid pressure, steering wheel movement, seat belt buckled/unbuckled as well as other operating data. A second plurality of sensors 64 may be installed on different parts of the body of the vehicle 60. The sensors 64 may be installed on a front/rear bumper, side panels/fenders, rear quarter panels, doors, hood, trunk, chassis and the like. The sensors 64 may be used to monitor impact data on the different parts of the body of the vehicle 60 during an accident. In accordance with one embodiment, the sensors 64 may be accelerometers. Piezoelectric accelerometers have been shown to provide very accurate impact data.

The sensors 62 and 64 may send monitored data to an event data recorder (EDR) 66 of the vehicle 60. The EDR 66 may continuously monitor and record the data from the sensors 62 and 64. In the event of an accident, the EDR 66 may record the data transmitted by the sensors 62 and 64 at the time of the accident. If the readings monitored and record, exceed a predetermined threshold, the EDR 66 may transmit this information. For example, if the speed exceeded a certain predefined level, impact monitored/recorded exceeded a certain G-force reading or the like, the EDR 66 may transmit this information. The transmission may be a wireless transmission such as via Bluetooth, cellular, satellite or the like. In accordance with one embodiment, the EDR 66 may transmit this information to the server 14.

Alternatively, the EDR 66 may transmit the information once a connection with a computer 18 has been established. For example, once the EDR 66 and computer 18 are paired together. In this embodiment, if the readings monitored and record exceed a predetermined threshold, the EDR 66 may transmit this information to a computer 18, which may forward this information to the server 14.

The EDR 66 may have a built-in transmitter. The transmitter may allow the EDR 66 to transmit the data monitor by the sensors 62 and 64. Alternatively, a transmitting dongle may be coupled to the vehicle 60 and the EDR 66 to allow the EDR 66 t transmit the data monitor by the sensors 62 and 64. In another embodiment, as disclosed above, the EDR 66 may transmit, the information once a connection with a computer 18 has been established. For example, once the EDR 66 and computer 18 are paired together. In this embodiment, the readings monitored and record by the EDR 66 may be transmitted to a computer 18, which may forward this information to the server 14.

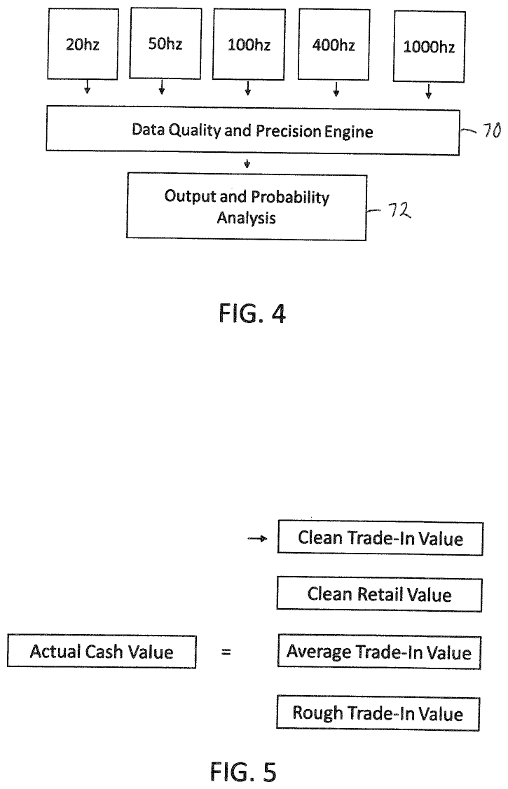

Referring to the FIGS. one embodiment of operation of the application 12 may be described. The application 12 may be able to download data, from any device or combination of sensors and devices, including smart phones, dongles, OBD II devices, 12-volt adaptors, OEM, engine control modules, and the like. The server 14 with the application 12 may have a transceiver which may be able to receive transmissions from different devices on differing frequencies. As may be seen in FIG. 4, the application 12 may be take this data from the different devices on differing frequencies and send it to a processing engine 70. The processing engine 70 may be used to allow data of different formats and integrities to be collected and analyzed. For example, data providers generally label and format event data in different manners. Lateral acceleration may be labeled “x” axis accelerometer data while another company labels this data as being recorded on the “y” axis. The processing engine 70 may use an Extract-Transform-Load (ETL) tool to identify, parses and appropriately inputs event data regardless of the reporting format. An analysis engine may then output on whether the vehicle 60 should be repaired, salvage or the like.

As may be seen in FIG. 5, the application 12 may allow users to adjust seventy configurations in order for the analysis engine 72 to determine the probability of an event and outcome. In general, the application 12 may allow the client the option to selecting a vehicle valuation to be represented as the “actual cash value”. As may be see in FIG. 5, different valuations may be used to determine the “actual cash value”. These may include, but are not limited to: Clean Trade-In Value, Clean Retail Value, Average Trade-In Value, Rough Trade-In Value, A Clean Trade-In Value may reflect a vehicle 60 in clean condition. This means a vehicle 60 with no mechanical defects and passes all necessary inspections with ease. Paint, body and wheels have minor surface scratching with a high gloss finish and shine. Interior reflects minimal soiling and wear with all equipment in complete working order. The vehicle 60 would have a clean title history and would need minimal reconditioning to be made ready for resale. An Average Trade-In Value may reflect a vehicle 60 in average condition that is mechanically sound but may require some repairs/servicing to pass all necessary inspections. Paint, body and wheel surfaces may have moderate imperfections and an average finish and shine which can be improved with restorative repair. Interior reflects some soiling and wear in relation to vehicle age, with all equipment operable or requiring minimal effort to make operable. The vehicle 60 should have a clean title history and may need a fair degree of reconditioning to he made ready for resale. A Rough Trade-In Value may reflect a vehicle 60 in rough condition, meaning significant mechanical defects requiring repairs in order to restore reasonable running condition. Paint, body and wheel surfaces have considerable damage to their finish, which may include dull or faded (oxidized) paint, small to medium size dents, frame damage, rust or obvious signs of previous repairs. Interior reflects above average wear with inoperable equipment, damaged or missing trim and heavily soiled/permanent imperfections on the headliner, carpet, and upholstery. The vehicle 60 may have a branded title and un-true mileage and may need substantial reconditioning and repair to be made ready for resale. The client can pre-set the vehicle valuation criteria, which applies to all crash events. Once the client has determined the condition of the vehicle 60 pre-accident, the client may select the appropriate valuation.

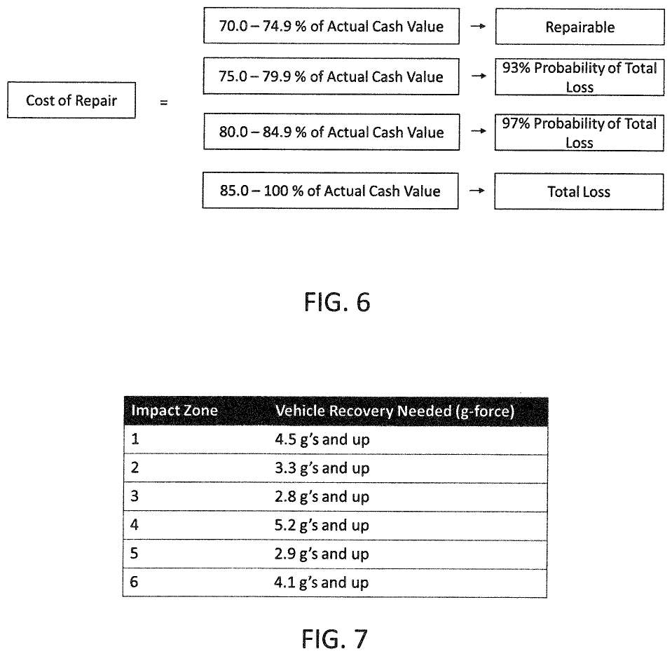

In accordance with one embodiment, the application 12 may use an adjustable total loss, identification model that may allow the client to configure the percentage of a vehicles' actual cash value compared to the estimated cost of repair during the total loss evaluation process. These percentages may be used to determine the probability of the vehicle being considered a Total Loss after the accident. As may be seen in FIG. 6, after the application 12 has calculated a Cost of Repair, the Cost of Repair value may be compared to different percent ranges of the “actual cash value” discussed above in order to determine the probability of the vehicle being considered a Total Loss after the accident.

In the embodiment shown in FIG. 6, the client has set the percentages such that if the cost of repairs is less than 74.9% of the “actual cash value”, the vehicle 60 is repairable. If the cost, of repair is between 75% and 79.9% of the “actual cash value”, there is a 93% chance that the vehicle 60 may be considered a total loss. If the cost of repair is between 80% and 84.9% of the “actual cash value”, there is a 97% chance that the vehicle 60 may be considered a total loss. If the cost of repair is greater than 85% of the “actual cash value”, the vehicle 60 may be considered a total loss.

The application may allow the client to manage vehicle recovery. In accordance with the embodiment shown in FIG. 7, allow the client to manage vehicle recovery based on the force at impact. As may be seen in FIG. 7, the sensors 64 may monitor the force of impact at different areas of the vehicle 60. As different areas of the vehicle 60 may be able to handle harder impacts, different areas of the vehicle may have different set points on when to determine if vehicle recovery is warranted. As may be seen in FIG. 7, the set point for redetermining if vehicle recovery may be required is if the sensors 64 monitored an impact equal or greater than 4.5G in Impact Zone 1, 33G in Impact Zone 2, 2.8G in Impact Zone 3, 5.2G in Impact Zone 4, 2.9G in Impact Zone 5, and 4.1G in Impact Zone 6. The above is given as one example and should not be seen in a limiting manner.

In accordance with one embodiment, if the readings monitored and record for impact of the vehicle 60 exceeded a certain G-force reading, the EDR 66 may send wireless signals to the server 14, which may contact an operator and/or alerting emergency responder of the impact. In accordance with one embodiment, the operator may contact the operator of the vehicle 60 to see if emergency responders are required.

As shown above, the plurality of functions provided in the application 12 may be configurable for client selected tolerances/threshold levels. The application 12 is designed to be flexible enough to accommodate a wide variety of industry best practices in terms of crash event analysis sequence, remedial action procedures, and other insurance carrier specific internal processes.

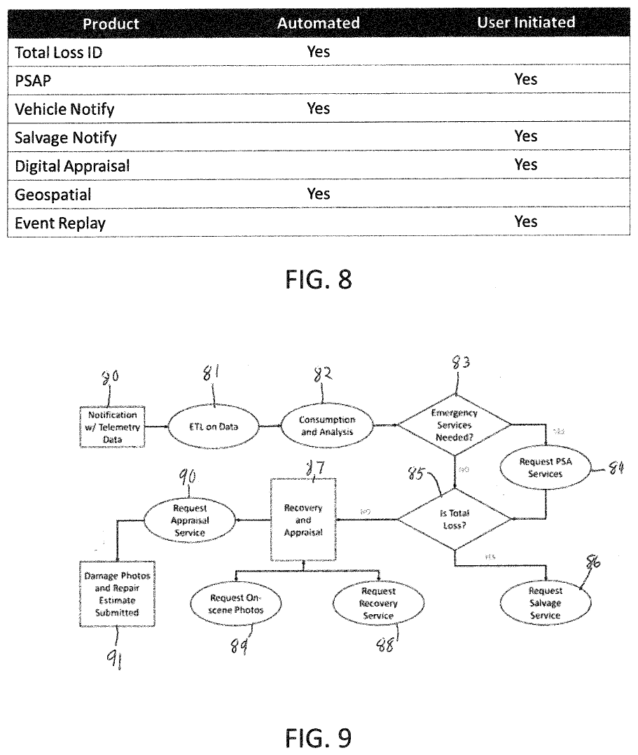

As may be seen in FIG. 8, the plurality of functions provided in the application 12 may be configurable not only for client selected tolerances/threshold levels, but whether the client would like the functions to be automated. Thus, the application 12 allows the client to have several options when configuring which products and actions are fully automated and which require “user initiated” action. For example, one client may choose to automate the vehicle recovery process by system notification to a vendor, while others may elect to review data prior to initiating the action.

Based on the information downloaded, the application 12 may provide a mechanism to create and display renderings showing the seconds leading up to a crash event as well as a display of post vehicle movement. This replay feature can show in either “real time” or in a slower, frame-by-frame visualization. This may be presented as a top-down map-style replay overlaid on either a map or satellite image interface.

The system 10 may be designed to improve the accuracy of the analysis models, as well as build a body of data for relevant non-normal event details. A machine learning analysis tool may be used for this purpose. The system 10 may combine descriptive statistics with inductive statistics to create multiple model sets that can be applied to an analysis activity using both supervised and unsupervised machine language technologies.

Referring to the FIGS., operation of the application 12 may be disclosed. As may be shown in FIG. 9, upon an initial event (i.e., accident) that exceeds a predetermined threshold monitored by the sensors 64, the application 12 may receive notification of the event as shown in 80. The application 12 may receive the data as disclosed above. The application 12 may receive and transforms data from the sensors 62 and 64 into a common class consumable by the system 10 as shown in 81. In accordance with one embodiment, if the vehicle 60 has a telemetry provider, the notification and transfer of the data from the sensors 62 and 64 may be directly sent from the vehicle 60 to the system 10 notifying the system of the event. The application 12 on the server 14 may then receive, transform and analyze the data,

In accordance with one embodiment, the data received by the application 12 may include an identifying key that describes what company/format from which the data is coming from. Using the provided identifier, the system 10 may find a dictionary that describes how to map the incoming data to a Standard Data Model of the application 12 to transform the telemetry data to a common standard data. This may allow the application 12 to be fully configurable and accommodate all known data providers, including telematic service providers (TSP).

The transformed data may then be analyzed as may be seen in 82. Using the now standardized data, the application 12 may run a series of analyses on the event data to determine the severity of event as it relates to the need for emergency management and public safety services, calculate damage based on configuration, and 3^{rd} party valuation services (e.g. NADA/JD Power and Associates), and generate event descriptions that show in plain language where, when, how, and what the incident involved.

The application 12 may determine if emergency services are needed as shown in 83. The application 12 may analyze the data from the sensors 64 to determine the impact force monitored at different impact zones of the vehicle 60. If the impact force at any of the impact zones exceeds the threshold limits, the application may request emergency responders be sent to the location of the event as shown in 84. This request may be automatic and sent immediately upon the application 12 receiving the impact data. The application may further send other details to the emergency responders such as time of the event, description of the vehicle 60 such as the make and model, as well as other relevant information.

The location of the event may be determined by the GPS coordinates of the vehicle 60 as determined by a GPS unit of the vehicle 60 in communication with the EDR 66. Alternatively, the location of the vehicle 60 may be determined by GPS coordinates of the computer 18 running the application 12, if the computer 18 is the driver/passenger of the vehicle 60. If the impact force at any of the impact zones does not exceed the threshold limits, the application 12 may not automatically request emergency responders be sent to the location of the, event. However, the driver/passengers of the vehicle 60 or other vehicles involved in the event may still contact emergency responders.

The application 12 may then may a determination of whether the vehicle 60 is considered to be a total loss as shown in 85. If the vehicle 60 is determined to be a total loss, the application 12 may request salvage service as shown in 86. In order to request salvage service, a vendor may need to be selected. The application 12 may list one or more vendors that is geographically appropriate for the location of the event and send a notification to the selected vendor. These coverages are configurable in the system 10 by the customer to tailor their area coverage for cost efficiency and timeliness of service.

If the vehicle 60 is not determined to be a total loss, the application 12 may perform a recovery/appraisal process as shown in 87. The details of the recovery/appraisal process will be disclosed below. In general, if the application 12 determines that the vehicle 60 may be reparable, then an analysis may be performed by the application 12 to determine if the vehicle 60 may be drivable after the occurrence of the event such as the case of a minor accident. If the vehicle 60 is not deemed safely drivable based on client configured thresholds, then a recovery vendor may be requested as shown in 88. The recovery vendor may be selected using the same or similar process as selecting a salvage vendor disclosed above. The application 12 may list one or more vendors that is geographically appropriate for the location of the event and send a notification to the selected recovery vendor.

During the recovery/appraisal process, the application 12 may request on-scene photos as may be seen in 89. The application 12 may prompt the driver to take and upload photos of the event to the system 10. The application 12 may instructs the driver at the scene to take photos immediately of the driver's vehicle 60, other vehicles involved with the event, accident scene as well as other similar photos. The photos may be routed external to the system 10 to protect driver identity.

In any event where the vehicle 60 is not deemed a total loss, the application 12 may allow one to select an appropriate digital appraisal vendor (i.e., repair shop) as shown in 90. The digital appraisal vendor may be selected using the same or similar process as selecting a salvage vendor disclosed above. The application 12 may list one or more vendors that is geographically appropriate for the location of the event and send a notification to the selected recovery vendor. Alternatively, or in addition to, the application 12 may base the digital appraisal vendor on those approved for specific insurance companies as well as geographically.

Once a digital appraisal vendor has been selected, the application 12 may set-up and send the digital appraisal vendor a unique link and portal for the specific case as shown in 91. The digital appraisal vendor may use the unique link and portal to photograph the vehicle damage, upload those photos, and to upload a detailed damage estimate PDF when it is ready. The driver of the vehicle 60 may also receive the unique link and portal for the specific case in order to view the photos and to see the detailed damage estimate PDF when it is ready.

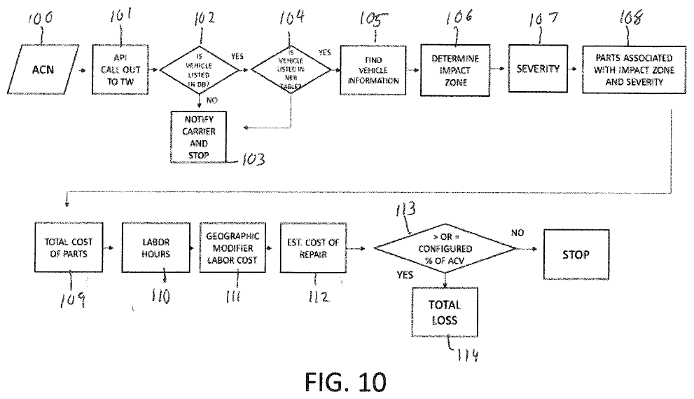

As may be seen in FIG. 10, a flowchart may be seen showing how the application 12 determines if the vehicle 60 involved in the event should be deemed a total loss. In general, the application 12 determines if the vehicle 60 is deemed a total loss by taking into account, the angle of impact, severity of impact, vehicle composition, actual cash value of the vehicle, estimated cost of parts, estimated cost of labor and an overall evaluation comparing the estimated repair costs to the vehicle's actual cash value to determine if a vehicle is economically repairable.

As may be seen in FIG. 10, in step 100, the telemetry provider may contact the system 10 with notification and data regarding an event that has just occurred to the vehicle 60. This data include an identifying key that describes what company the data is coming from. In step 101, in the application 12, the API may call out to a third-party VIN decoding service returning year, make, model, trim specs and multiple vehicle valuations in which client has predetermined which valuation is used in analysis of total loss. A determination of whether the vehicle 60 may be found in the third-party database may be performed in step 102. If the vehicle 60 is not found in the database, the application 12 may notify the individual and stop as shown in 103. If the vehicle 60 is found in the database, a determination is made if the vehicle 60 is found in the database of the system 10 as shown in 104. If not, then the application 12 may stop and a notification is sent to the individual as shown in 103. If the vehicle 60 is found in the database of the system 10, then information within the system database relating to vehicle type, vehicle damage, part cost and labor hours may be obtained as shown in 105.

The vehicle data downloaded from the sensors 62 and 64 may be obtained by the application 12 in order to determine an angle of impact, impact zones and the like as shown in 106. The application 12 may then determine the severity of the event from analysis of event data as shown in 107 coupled with a damageability differential assigned to the vehicle 60 from step 105. The application 12 may then identify all the parts of the vehicle 12 that may have been damaged from known impact zone and severity level from the data of the sensors 62 and 64 as shown in 108. Based on the parts of the vehicle 60 that have been identified as being damaged, and the severity of the damage, the application 12 may calculate the cost of all the parts involved as shown in 109 referencing a part cost multiplier assigned to the vehicle in step 105.

The number of hours to fix the vehicle 60 may then be calculated as shown in 110. The number of hours may be based on information stored in databases relating to previous experiences with similar damage to a similar vehicle 60. Geographic modifiers may use event location to assign a known average labor rate in determining cost of labor as shown in 111. The application 12 may then calculates an estimated cost of repair as shown in 112. Total loss determination compares repair cost to the client configured vehicle valuation (ACV) as shown in 113. If the estimated cost of repair is greater than or equal to (X %) of the vehicles actual cash value, then it is deemed a total loss as shown in 114. If not, then the vehicle 60 may be deemed repairable.

The system 10 is a managed service that is designed to run concurrently with existing insurance systems and workflows, requiring minimal integration and only nominal configuration. While other systems are designed to be process improvement tools for internal teams, the system 10 is designed from both a system and workflow paradigm to be a process automation product. By allowing data feeds to be fully configurable from, within the system 10, it is possible to accommodate a wide range of system, office, and personnel workflows without the need to perform extensive process modifications, saving users significant time and money in infrastructure changes.

The system 10 allows users to have control over what it constitutes as a “Total Loss” by setting thresholds thorough a unique configuration tool. Users also have control over deciding what processes should be fully automated, semi-automated, and what should be left to personnel evaluation and resolution. Additionally, workflows in the system 10 are designed to be flexible enough to accommodate a wide variety of industry best practices in terms of crash event analysis sequence, remedial action procedures, and other insurance carrier specific internal processes.

Starting with an initial event, the application 12 may transforms the data from the sensors 62 and 64 into a common class consumable by the system 10. This is critical to allowing data of different formats and integrities to be analyzed by the system 10. This data is then used by the analysis engine 72 where a series of calculations and evaluations are done. The analysis engine 72 may use a comparative model where the event data is compared to various models in the system 10, denoting damage and driver severity for the purposes of determining appropriate remedial actions. This model, combined with client configuration parameters, answers two critical questions: (1) Are emergency services required? (2) Is the vehicle reparable?

The application 12 may be configured to receive event data from a vehicle 60 involved in a collision. The application 60 may parses and input this data into a total loss identification component. The total loss identification component estimates if the vehicle 60 involved in the collision is a total loss. Following this determination, a series of client configured automated actions ensue. These actions include but are not limited to; communication to a vehicle recovery vendor; communication to a vehicle salvage vendor; communication to a PSAP vendor; generation of an event reconstruction interface; communication to carrier and policy holder prompting digital photo appraisal; communication to a damage appraiser; communication to proprietary/third party crowdsourcing and the like.

The foregoing description is illustrative of particular embodiments of the invention, but is not meant to be a limitation upon the practice thereof. The following claims, including all equivalents thereof, are intended to define the scope of the invention.

What is claimed is:

1. A computing device comprising:
a processor;
a display coupled to the processor;
a user interface coupled to the processor for entering data into the computing device; and
a memory coupled to the processor, the memory storing program instructions that when executed by the processor, causes the processor to:
receive telemetry data from a vehicle involved in an accident;
map the incoming data to a standard data model to transform the telemetry data to a common standard data;
analyze the common standard data;
determine estimated repair cost of the vehicle based on the analysis of the common, standard data;
determine if the repair cost exceeds a predetermined threshold percentage of an actual cash value of the vehicle; and
request a salvage service if the repair cost exceeds the predetermined threshold percentage of the actual cash value of the vehicle.

2. The computing device of claim 1, wherein the memory causes the processor to determine if emergency responders are needed.

3. The computing device of claim 1, wherein the memory causes the processor to:
determine if emergency responders are needed by analyzing the common standard data shows to see if an impact to the vehicle is above a predetermined threshold value;
notify the emergency responders when the impact to the vehicle exceeds the predetermined threshold value; and
provide emergency responders with description of the vehicle and coordinates of the vehicle.

4. The computing device of claim 1, wherein the memory causes the processor to:
analyze the common standard data shows to see if an impact to the vehicle is below a minimum threshold indicating the vehicle is drivable; and
contact a recovery service is the vehicle is determined not to be drivable.

5. The computing device of claim 1, wherein the memory causes the processor to prompt a driver of the vehicle to take and upload photos of the vehicle.

6. The computing device of claim 1, wherein the memory causes the processor to:
select an appraiser for repairing the vehicle;
establish a unique link for the selected appraiser, the link allowing the appraiser to upload photos and a quote for repairs.

7. The computing device of claim 1, wherein receiving the telemetry data from a vehicle comprises receiving the telemetry data having an identifying key describing a company from which the data is associated with.

8. The computing device of claim 1, wherein determining if the repair cost exceeds a predetermined threshold percentage of an actual cash value of the vehicle comprises:
determine year, make, model, trim specs and multiple vehicle valuations of the vehicle;
determine areas of impact to the vehicle and severity of impact in each area;
identify parts to be replaced or repaired based on the areas of impact to the vehicle;
determine labor cost for replacing or repairing the parts identified;
determine total cost of repairs, including labor.

9. The computing device of claim 8, wherein determining labor cost comprises applying a geographic modifier to adjust labor cost based on location.

10. The computing device of claim 1, wherein the actual cash value is user adjustable.

11. The computing device of claim 1, wherein the actual cash value is user selectable and selected between one of: clean trade-in value, clean retail value, average trade-in value and rough trade-in value.

12. A method of determining when a vehicle is repaired or salvaged after an accident comprising:
receiving telemetry data from a vehicle involved in an accident;
mapping the incoming data to a standard data model to transform the telemetry data to a common standard data;
analyzing the common standard data;
determining estimated repair cost of the vehicle based on the analysis of the common standard data;
determining if the repair cost exceeds a predetermined threshold percentage of an actual cash value of the vehicle;
requesting a salvage service if the repair cost exceeds the predetermined threshold percentage of the actual cash value of the vehicle;
selecting an appraiser for repairing the vehicle if the repair cost is below the predetermined threshold percentage of the actual cash value of the vehicle; and
establishing a unique link for the selected appraiser, the link allowing a user to upload images of the vehicle.

13. The method of claim 12, comprising:
determining if emergency responders are needed by analyzing the common standard data shows to see if an impact to the vehicle is above a predetermined threshold value;
notifying the emergency responder when the impact to the vehicle exceeds the predetermined threshold value; and
providing emergency responders with description of the vehicle and coordinates of the vehicle.

14. The method of claim 12, comprising
analyzing the common standard data shows to see if an impact to the vehicle is below a minimum threshold indicating the vehicle is drivable; and
contacting a recovery service is the vehicle is determined not to be drivable.

15. The method of claim 12, comprising prompting a driver of the vehicle to take and upload photos of the vehicle after the accident.

16. The method of claim 12, wherein receiving the telemetry data from a vehicle comprises receiving the telemetry data having an identifying key describing a company from which the data is associated with.

17. The method of claim 12, wherein determining if the repair cost exceeds a predetermined threshold percentage of an actual cash value of the vehicle comprises:
determining year, make, model, trim specs and multiple vehicle valuations of the vehicle;
determining areas of impact to the vehicle and severity of impact in, each area;
identifying parts to be replaced or repaired based on the areas of impact to the vehicle;
determining labor cost for replacing or repairing the parts identified;
determining total cost of repairs, including labor.

18. The method of claim 17, wherein determining labor cost comprises applying a geographic modifier to adjust labor cost based on location.

19. The method of claim 12, wherein the actual cash value is user adjustable.

20. The method of claim 12, wherein the actual cash value is user selectable and selected between one of: clean trade-in value, clean retail value, average trade-in value and rough trade-in value.
